(19) United States
(12) Patent Application Publication
(10) Pub. No.: US 2006/0171140 A1
(43) Pub. Date: Aug. 3, 2006

(54) Supporting member, backlight assembly and display apparatus of the same

(76) Inventor: Hyun-Chul Bae, Suwon-si (KR)

Correspondence Address: CANTOR COLBURN, LLP, 55 GRIFFIN ROAD SOUTH, BLOOMFIELD, CT, 06002, US

(21) Appl. No.: 11/344,794

(22) Filed: Jan. 31, 2006

(30) Foreign Application Priority Data
Jan. 31, 2005 (KR) 2005-8413

(51) Int. Cl. G01D 11/28

(52) U.S. Cl. 362/29; 362/382

(57) ABSTRACT

A backlight assembly includes a surface light source device, an optical member, a supporting member and a receiving container. The surface light source device includes a first substrate and a second substrate facing the first substrate to form a light-emitting region and a non-emitting region. The surface light source device generates light. The optical member enhances optical properties of the light generated by the surface light source device. The supporting member is disposed at the non-emitting region of the surface light source device to support the optical member. The receiving container receives the surface light source device and the optical member. Advantageously, sagging of the optical member is reduced, or effectively prevented, to enhance display quality.

This application claims priority to Korean Patent Application No. 2005-8413 filed on Jan. 31, 2005, and all the benefits accruing therefrom under 35 U.S.C. §119, the contents of which are herein incorporated by reference in its entirety.

### BACKGROUND OF THE INVENTION

1. Field of the Invention

The present invention relates to a supporting member, a backlight assembly having the supporting member and a display apparatus having the supporting member. More particularly, the present invention relates to a supporting member for supporting optical members, a backlight assembly having the supporting member and a display apparatus having the supporting member.

2. Description of the Related Art

A liquid crystal display (LCD) apparatus displays images by using liquid crystal. The LCD apparatus includes a liquid crystal control unit that controls an arrangement of liquid crystal molecules, and a light-providing unit that provides the liquid crystal control unit with light.

The light-providing unit includes a light source. A point light source such as a light emitting diode (LED), a linear light source such as a cold cathode fluorescent lamp (CCFL), and a surface light source such as flat fluorescent lamp (FFL) may be employed as the light source.

The surface light source is used for the LCD apparatus having a relatively large size. A general surface light source includes a plurality of light-emitting regions and a plurality of non-emitting regions. The light-emitting regions and the non-emitting regions are alternately disposed with each other, so that a bright region and a dark region may be alternately displayed to reduce a luminance uniformity.

In order to enhance the luminance uniformity, the LCD apparatus further includes a light-diffusing plate. The light-diffusing plate diffuses light generated from the surface light source to enhance the luminance uniformity. When the light-diffusing plate is spaced apart from the surface light source, the luminance uniformity is more enhanced.

However, when the light-diffusing plate is spaced apart from the surface light source, the light-diffusing plate sags due to a weight thereof to lower the luminance uniformity.

### SUMMARY OF THE INVENTION

The present invention provides a supporting member that is disposed between a surface light source device and a light-diffusing plate to support the light-diffusing plate.

The present invention also provides a backlight assembly having the above supporting member.

The present invention also provides a display apparatus having the above supporting member.

In an exemplary supporting member according to the present invention, the supporting member includes a fixing portion and a supporting portion. The fixing portion is disposed on a surface face of a light source device. The supporting portion is disposed on the fixing portion to support an optical member that enhances optical characteristics of light generated from the light source device.

In an exemplary backlight assembly according to the present invention, the backlight assembly includes a receiving container, a surface light source device, an optical member and a supporting member. The receiving container has a bottom plate. The surface light source device is disposed on the bottom plate of the receiving container. The surface light source device generates light. The optical member enhances optical property of the light generated by the surface light source device. The supporting member is disposed between the surface light source device and the optical member to support the optical member. The supporting member includes a fixing portion disposed on the surface light source device, and a supporting portion disposed on the fixing portion to support the optical member.

In another exemplary backlight assembly according to the present invention, the backlight assembly includes a surface light source device, an optical member, a supporting member and a receiving container. The surface light source device has a first substrate and a second substrate combined with the first substrate to form a light-emitting region and a non-emitting region. The surface light source device generates light. The optical member enhances optical properties of the light generated by the surface light source device. The supporting member is disposed at the non-emitting region of the surface light source device to support the optical member. The receiving container receives the surface light source device and the optical member.

In an exemplary display apparatus according to an exemplary embodiment of the present invention, the display apparatus includes a backlight assembly and a display panel. The backlight assembly generates light. The backlight assembly includes a surface light source device, an optical member, a supporting member and a receiving container. The surface light source device has a first substrate and a second substrate combined with the first substrate to form a light-emitting region and a non-emitting region. The surface light source device generates light. The optical member enhances optical properties of the light generated by the surface light source device. The supporting member is disposed at the non-emitting region of the surface light source device to support the optical member. The receiving container receives the surface light source device and the optical member. The display panel displays an image by using the light generated by the backlight assembly.

According to the present invention, the generation of sagging of the optical member is suppressed, so that display quality is enhanced.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a cross-sectional view illustrating an exemplary embodiment of a supporting member according to the present invention;

FIG. 2 is an enlarged view illustrating portion ‘A’ in FIG. 1;

FIG. 3 is a cross-sectional view illustrating another exemplary embodiment of a supporting member according to the present invention;

FIG. 4 is a cross-sectional view illustrating another exemplary embodiment of a supporting member according to still another exemplary embodiment of the present invention;

FIG. 5 is a perspective view illustrating the supporting member in FIG. 4;

FIG. 6 is a plan view illustrating another exemplary embodiment of a surface light source device having a supporting member according to the present invention;

FIG. 7 is a cross-sectional view taken along line I-I′ in FIG. 6;

FIG. 8 is a cross-sectional view taken along line II-II′ in FIG. 6;

FIG. 9 is a plan view illustrating another exemplary embodiment of a surface light source device having a supporting member according to the present invention;

FIG. 10 is a plan view illustrating an exemplary embodiment of a surface light source device having a supporting member according to the present invention;

FIG. 11 is a plan view illustrating another exemplary embodiment of a surface light source device having a supporting member according to of the present invention;

FIG. 12 is a plan view illustrating another exemplary embodiment of a surface light source device having a supporting member according to the present invention;

FIG. 13 is a cross-sectional view illustrating another exemplary embodiment of a backlight assembly according to the present invention;

FIG. 14 is a plan view illustrating another exemplary embodiment of a backlight assembly according to the present invention;

FIG. 15 is a cross-sectional taken along line III-III′ in FIG. 14;

FIG. 16 is an enlarged view illustrating portion ‘B’ in FIG. 15;

FIG. 17 is a cross-sectional taken along line IV-IV′ in FIG. 14;

FIG. 18 is a cross-sectional view illustrating another exemplary embodiment of a backlight assembly according to the present invention;

FIG. 19 is a plan view illustrating another backlight assembly;

FIG. 20 is a cross-sectional view taken along line V-V′ in FIG. 19;

FIG. 21 is a plan view illustrating another exemplary embodiment of a backlight assembly according to the present invention; and

FIG. 22 is a cross-sectional view illustrating another exemplary embodiment of a display apparatus according to the present invention.

### DETAILED DESCRIPTION OF THE INVENTION

It should be understood that the exemplary embodiments of the present invention described below may be varied modified in many different ways without departing from the inventive principles disclosed herein, and the scope of the present invention is therefore not limited to these particular flowing embodiments. Rather, these embodiments are provided so that this disclosure will be thorough and complete, and will fully convey the concept of the invention to those skilled in the art by way of example and not of limitation.

In the drawings, the thickness of layers and regions are exaggerated for clarity. Like numerals refer to like elements throughout. It will be understood that when an element or layer is referred to as being “on”, “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the embodiments of the present invention will be described in detail with reference to the accompanied drawings.

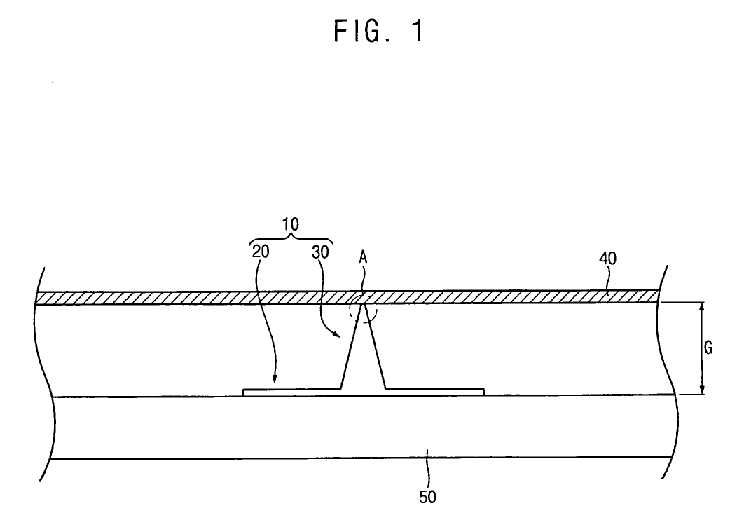

FIG. 1 is a cross-sectional view illustrating an exemplary embodiment of a supporting member according to the present invention.

Referring to FIG. 1, a surface light source device 50 generates two-dimensional light. An optical member 40 is disposed such that light generated from the surface light source device 50 passes through the optical member 40. The optical member 40 is disposed, exemplarily over the surface light source device 50. The optical member 40 may be, but is not limited to, for example, a light-diffusing plate.

The optical member 40 is spaced apart from the surface light source device 50 by a distance ‘G’. When the distance ‘G’ is non-uniform, luminance uniformity of light that exits the optical member 40 may be lowered.

The supporting member 10 is disposed between the surface light source device 50 and the optical member 40. The supporting member 10 supports the optical member 40, so that the distance ‘G’ is maintained to be substantially uniform.

The supporting member 10 may include a fixing portion 20 and a supporting portion 30. The supporting member 10 may include, but is not limited to, for example, an optically transparent material such as polyethyleneterephthalate (PET), polymethylmethacrylate (PMMA), polycarbonate (PC), or the like, as well as any combination including at least one of the foregoing.

Referring to FIG. 1, the fixing portion 20 is disposed on a face of the surface light source device 50. The fixing portion 20 may be disposed on a light-exiting face of the surface light source device 50. The fixing portion 20 essentially “fixes” the supporting portion 30 to the surface light source device 50. An adhesive member (not shown) may be disposed between the light-exiting face of the surface light source device 50 and the fixing portion 20 to fix the supporting member 10 to the surface light source device 50. In alternative embodiments, a two-sided adhesive tape may be employed as the adhesive member.

The supporting portion 30 may be formed or disposed on the fixing portion 20. The supporting portion 30 may make contact with the optical member 40 to support the optical member 40.

Referring to FIG. 1, the fixing portion 20 of the supporting member 10 has, for example, a plate shape, but may include any of a number of shapes suitable for the purpose described herein. The supporting portion 30 of the supporting member 10 has, for example, a cone shape. In alternative embodiments, the supporting member 30 may have a prism shape, a cylindrical shape, or the like, as well as any combination including at least one of the foregoing.

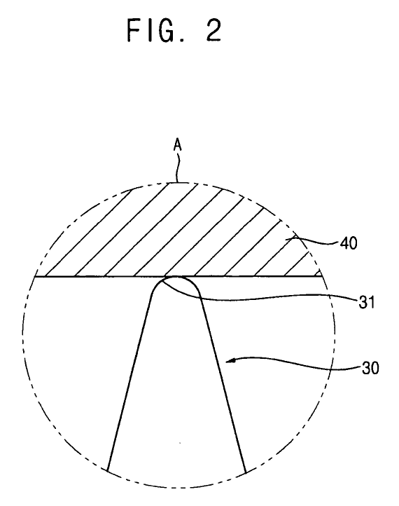

FIG. 2 is an enlarged view illustrating portion ‘A’ in FIG. 1.

Referring to FIGS. 1 and 2, the supporting portion 30 protrudes upwardly from the fixing portion 20. The supporting portion 30 has a cone shape.

When a contact area between the supporting portion 30 and the optical member 40 increases, light generated from the surface light source device 50 may be decayed by the supporting member 30 even though the supporting portion 30 may be transparent. In exemplary embodiments, to prevent light decaying, the contact area may be minimized. In order to minimize the contact area, the supporting portion 30 may have various shapes such as a polygonal pyramid shape, a cone shape, or the like, as well as any combination including at least one of the foregoing. The supporting portion 30 has in FIGS. 1 and 2, for example, a cone shape.

If a top 31 of the supporting portion 30 is too sharp, the top 31 of the supporting portion 30 and the optical member 40 may be damaged. In exemplary embodiments, to prevent the damage of the top 31 of the supporting portion 30 and the optical member 40, the top 31 of the supporting portion 30 may have a rounded shape.

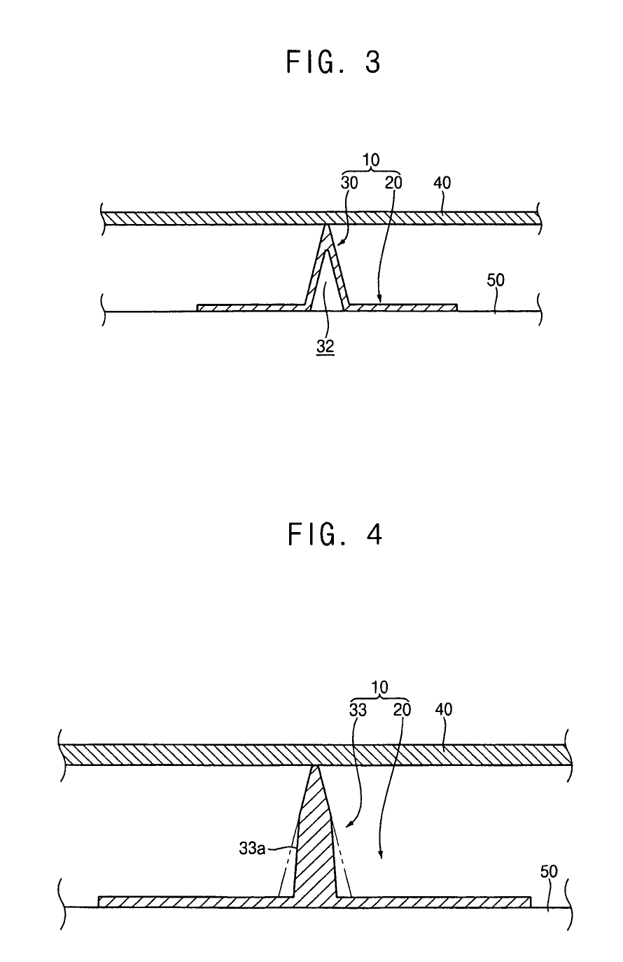

FIG. 3 is a cross-sectional view illustrating another exemplary embodiment of a supporting member 10 according to the present invention. The supporting member 10 of the present embodiment is same as in embodiment in FIGS. 1 and 2, except for a supporting portion 30. Thus, the same reference numerals will be used to refer to the same or like parts as those described in embodiment in FIGS. 1 and 2 and any further explanation concerning the above elements will be omitted.

Referring to FIG. 3, a supporting portion 30 of the supporting member 10 includes an inner space 32. A thickness of a fixing portion 20 may be substantially same as a thickness of the supporting portion 30. When the supporting portion 30 has a substantially same thickness as that of the fixing portion 20 (or when the supporting portion 30 has the inner space 32), advantageously, the supporting member 10 supports the optical member 40 more effectively, due to an arch-shape of the supporting member 10.

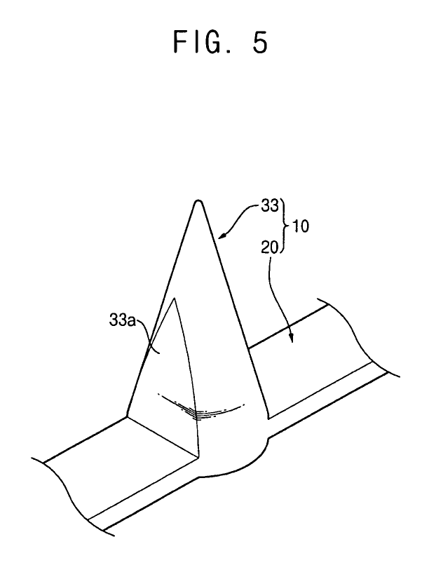

FIG. 4 is a cross-sectional view illustrating another exemplary embodiment of a supporting member 10 according to the present invention, and FIG. 5 is a perspective view illustrating the supporting member 10 in FIG. 4. The supporting member 10 of the present embodiment is the same as in embodiment in FIGS. 1 and 2 except for a supporting portion 30. Thus, the same reference numerals will be used to refer to the same or like parts as those described in embodiment in FIGS. 1 and 2 and any further explanation concerning the above elements will be omitted.

Referring to FIGS. 4 and 5, a supporting member 10 includes a supporting portion 33 and a fixing portion 20. The supporting portion 33 makes contact with an optical member 40 to support the optical member 40, and the fixing portion 20 fixes the supporting portion 33 to a surface light source device 50. Light generated from the surface light source device 50 may be decayed by the supporting portion 33 to induce a dark region that is displayed through the optical member 40.

An area of the dark region may increase when a contact area between the supporting portion 33 and the optical member 40, and a length of the lower portion of the supporting portion 33 connected to the fixing portion 20 increases.

In exemplary embodiments, to reduce the length of the lower portion of the supporting portion 33, the supporting member 10 may further include a luminance-uniformizing section 33a. For example, a side portion of the supporting portion 33 may be removed to form the luminance-uniformizing section 33a. In alternative embodiments, two to four luminance-uniformizing sections 33a may be formed at the side portions of the supporting portion 33.

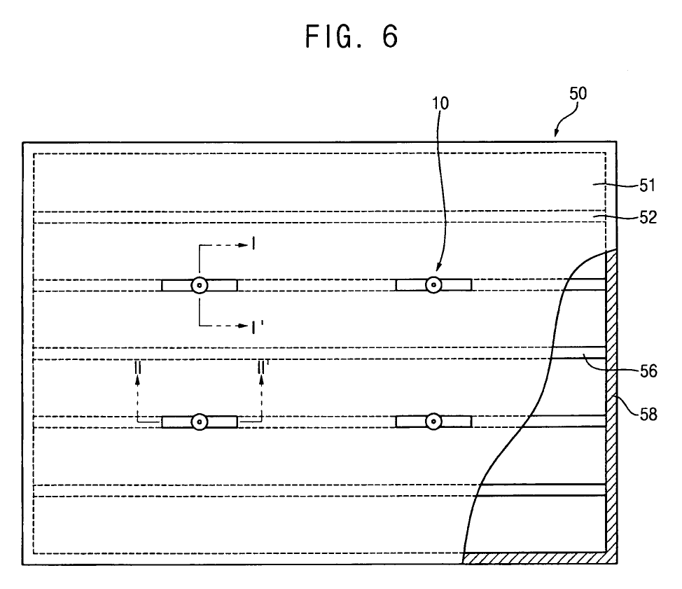

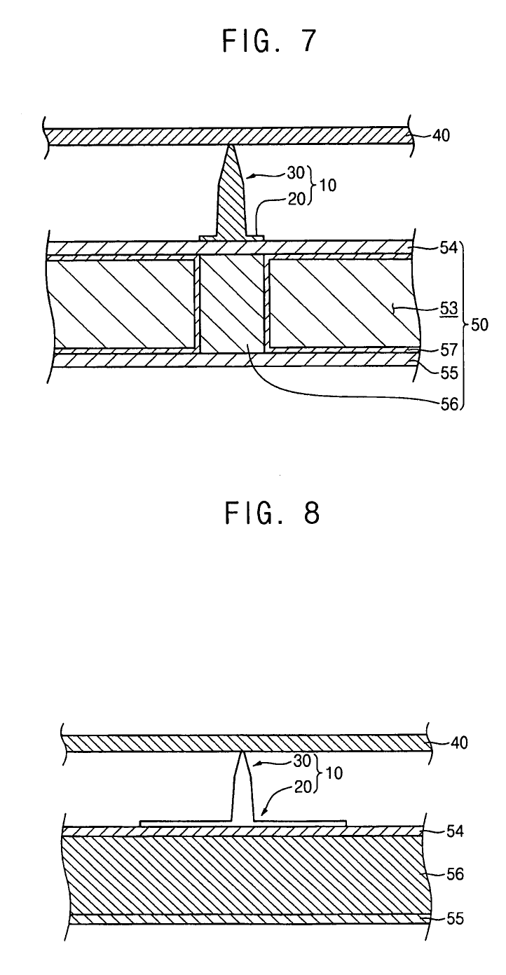

FIG. 6 is a plan view illustrating an exemplary embodiment of a surface light source device 50 having a supporting member 10 according to the present invention. FIG. 7 is a cross-sectional view taken along line I-I′ in FIG. 6, and FIG. 8 is a cross-sectional view taken along line II-II′ in FIG. 6. The supporting member 10 of the present embodiment is same as in embodiment in FIGS. 1 and 2 except for a position of a supporting portion. Thus, the same reference numerals will be used to refer to the same or like parts as those described in embodiment in FIGS. 1 and 2 and any further explanation concerning the above elements will be omitted.

Referring to FIGS. 6, 7 and 8, a surface light source device 50 includes, for example, a rectangular plate shape. In exemplary embodiments, the shape of the surface light source device 50 may include any of a number of shapes suitable for the purpose described herein. The surface light source device 50 includes a plurality of light-emitting regions 51 and a plurality of non-emitting regions 52. Light may be emitted only through the light-emitting regions 51. The light-emitting regions 51 and the non-emitting regions 52 may alternate with each other.

The light-emitting region 51 and the non-emitting region 52 extend along a longitudinal direction of the surface light source device 50. The light-emitting region 51 and the non-emitting region 52 may be substantially parallel to each other. Each of the light-emitting region 51 has a first area, and each of the non-emitting region 52 has a second area that is smaller than the first area of the light emitting region 51.

The surface light source device 50 may include a first substrate 54, a second substrate 55, a sealing member 58, a partition member 56, a first electrode (not shown) and a second electrode (not shown). The first and second substrates 54 and 55 face each other. The sealing member 58 may be disposed between the first and second substrates 54 and 55 to define an inner space between the first and second substrates 54 and 55. The partition member 56 divides the inner space at least two discharge spaces.

In exemplary embodiments, discharge gas 53 may be injected into the discharge spaces. A fluorescent layer 57 may be formed on a surface that makes contact with the discharge spaces.

The first and second electrodes may be disposed on at least one of the first and second substrates 54 and 55. The first and second electrodes may be disposed at first and second ends of the first and second substrates 54 and 55, the ends being opposite to each other. The first and second electrodes may be disposed such that a longitudinal direction of the first and second electrodes is substantially perpendicular to a longitudinal direction of the light-emitting regions 51. An electric power may be applied to the discharge gas 53 to generate invisible light. The invisible light then may be converted into visible light by the fluorescent layer 57.

A dark region may be induced due to the partition member 56 that defines the discharge spaces. In exemplary embodiments, to reduce the dark region, the surface light source device 50 may further include an optical member 40. The optical member 40 may be disposed over the first substrate 54. The optical member 40 may be spaced apart from the first substrate 54 to enhance luminance uniformity.

When the optical member 40 is spaced apart from the first substrate 54, the optical member 40 may sag due to the weight thereof. When the optical member 40 sags, luminance uniformity may be reduced.

In exemplary embodiments, to prevent sagging of the optical member 40, a supporting member 10 may be disposed between the first substrate 54 and the optical member 40. The supporting member 10 may be disposed, for example, on the non-emitting region 52. Advantageously, when the supporting member 10 is disposed on the non-emitting region 52, a luminance and a luminance uniformity may be enhanced.

The supporting member 10 may include a fixing portion 20 and a supporting portion 30. The fixing portion 20 may have, for example, a rectangular plate shape, but may include any of a number of shapes suitable for the purpose described herein. In exemplary embodiments, the fixing portion 30 may have a substantially same width as that of the non-emitting region 52. The fixing portion 20 essentially “fixes” and supports the supporting portion 30, and the supporting portion 30 supports the optical member 40.

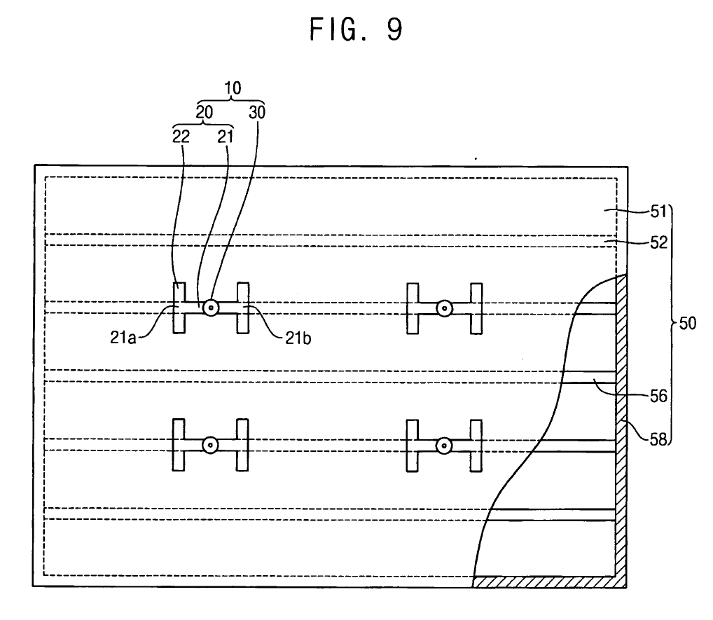

FIG. 9 is a plan view illustrating another exemplary embodiment of a surface light source device 50 having a supporting member 10 according to the present invention. The surface light source device 50 of the present embodiment is same as in embodiment in FIGS. 6 through 8 except for a fixing portion 20. Thus, the same reference numerals will be used to refer to the same or like parts as those described in embodiment in FIGS. 6 through 8 and any further explanation concerning the above elements will be omitted.

Referring to FIG. 9, a fixing portion 20 includes a first fixing piece 21 and a second fixing piece 22. The first fixing piece 21 has a plate shape, but may include any of a number of shapes suitable for the purpose described herein. In exemplary embodiments, the first fixing piece 21 may be disposed on the non-emitting region 52. A supporting portion 30 may be formed on the first fixing piece 21.

The second fixing piece 22 has a plate shape, but may include any of a number of shapes suitable for the purpose described herein. The second fixing piece 22 may be extended along a direction that is substantially perpendicular to a longitudinal direction of the first fixing piece 21. In exemplary embodiments, the second fixing piece 22 may be extended from a first end portion 21a of the first fixing piece 21 toward one of the light-emitting region 51. In other exemplary embodiments, more than one of the second fixing piece 22 may be extended in substantially opposite directions from a first end portion 21a of the first fixing piece 21 toward light-emitting regions 51 to form a T-shape. In alternative embodiments one or more of the second fixing piece 22 may extend from the second end portion 21b of the first fixing piece 21 to form the T-shape.

In exemplary embodiments, more than one of the second fixing pieces 22 may be disposed at opposite end portions 21a and 21b of the first fixing piece 21 to form an H-shape. The fixing portion 20 may be fixed tightly due to the second fixing piece 22.

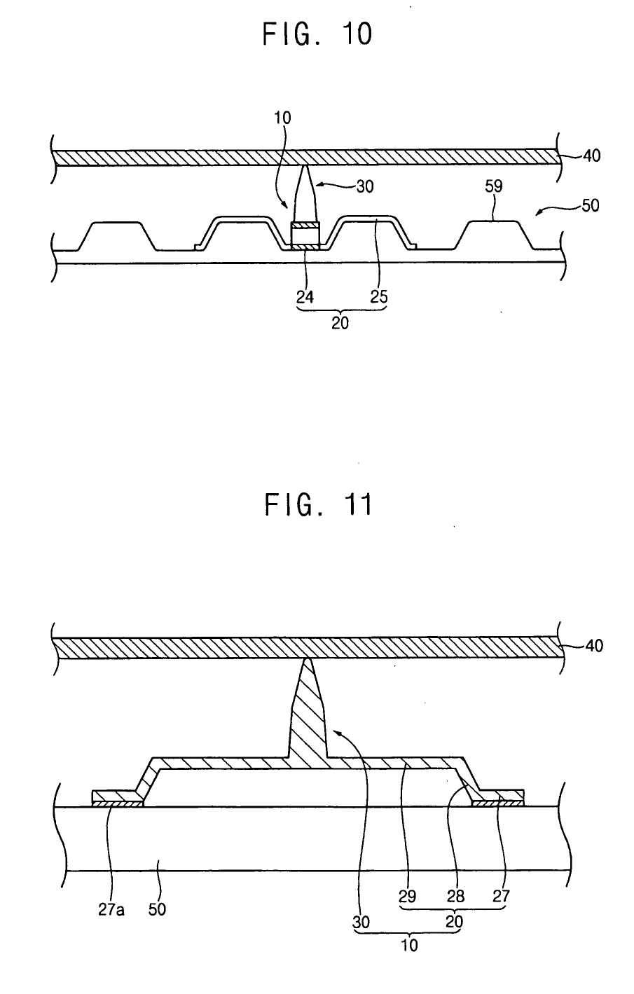

FIG. 10 is a plan view illustrating another exemplary embodiment of a surface light source device 50 having a supporting member 10 according to the present invention. The supporting member 10 of the present embodiment is same as in embodiment in FIG. 9 except for a fixing portion 20. Thus, the same reference numerals will be used to refer to the same or like parts as those described in embodiment in FIG. 9 and any further explanation concerning the above elements will be omitted.

Referring to FIG. 10, a first substrate has a plurality of ridges 59 and a plurality of grooves that make contact with a second substrate (not shown). The ridges and the grooves alternate with each other. The grooves divide an inner space between the first and second substrates to a plurality of discharge spaces. In exemplary embodiments, the ridges may correspond to the light-emitting region 51 in FIG. 9, and the grooves may correspond to the non-emitting region 52 in FIG. 9. A cross section of the ridges may have various shapes such as a semicircle, a trapezoid, a triangle, a rectangle, but may include any of a number of shapes suitable for the purpose described herein. The ridges and the grooves may be extended, for example, along a longitudinal direction of the surface light source device 50.

In exemplary embodiments, the supporting member 10 may include a supporting portion 30 and a fixing portion 20. The fixing portion 20 may include a first fixing piece 24 and a second fixing piece 25. The first fixing piece 24 may be disposed along the grooves, and the second fixing piece 25 may be extended from an end portion of the first fixing piece 24 such that the longitudinal direction of the second fixing piece 25 is substantially perpendicular to a longitudinal direction of the first fixing piece 24, essentially forming a T-shape when viewed on a plane. The second fixing piece 25 may be curved along grooves and ridges, following a profile of a surface of the first substrate. In alternative embodiments, more than one of the second piece 25 may be extended from substantially opposite end portions of the first fixing piece 24, to form an H-shape.

The first fixing piece 24 supports the supporting portion 30, and the second fixing piece 25 fixes the first fixing pieces 24 to the surface light source device 50.

FIG. 11 is a plan view illustrating another exemplary embodiment of a surface light source device 50 having a supporting member 10 according to the present invention. The supporting member 10 of the present embodiment is same as in embodiment in FIG. 4 except for a fixing portion 20. Thus, the same reference numerals will be used to refer to the same or like parts as those described in embodiment in FIG. 4 and any further explanation concerning the above elements will be omitted.

Referring to FIG. 11, a fixing portion 20 includes a contact portion 27, a center portion 29 and a connecting portion 28.

The contact portion 27 makes contact with the surface light source device 50. The supporting member 10 is disposed on the surface light source device 50 through the contact portion 27. In exemplary embodiments, the contact portion 27 may be fixed to the surface light source device 50 through an adhesive member 27a. In alternative embodiments, a two-sided tape may be used as the adhesive member 27a. The center portion 29 may be spaced apart from the surface light source device 50. A gap between the center portion 29 and the surface light source device 20 50 may be substantially uniform. The connecting portion 28 connects the center portion 29 and the contact portion 27.

In exemplary embodiments, the supporting portion 30 may be disposed on the center portion 29. The supporting portion 30 supports an optical member 40, including, but not limited to, a light diffusing plate.

When compression is applied to the optical member 40, the compression is transferred to the supporting portion 30. The compression applied to the supporting portion 30 is buffered by the center portion 29 that is spaced part from the surface light source device 50 to reduce, or effectively prevent damage of the optical member 40 and the supporting member 10.

In exemplary embodiments, the connecting portion 27 may form an angle of about 30 degrees to about 60 degrees with respect to the surface light source device 50. When the angle is smaller than about 30 degrees, a gap between the center portion 29 and the surface light source device 50 may become too small to absorb the compression. When the angle is larger than about 60 degrees, a volume of the supporting member 10 may increase and the compression may not absorbed properly.

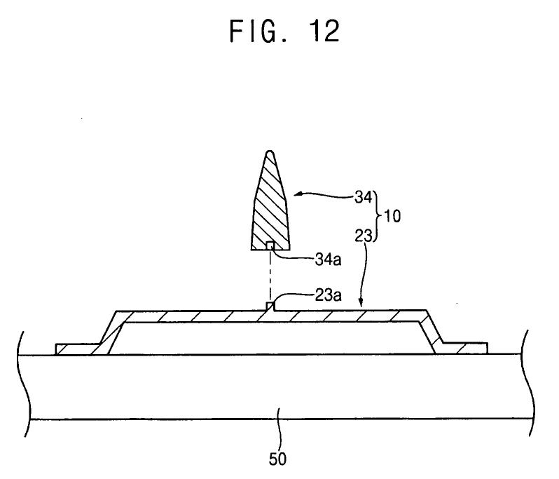

FIG. 12 is a plan view illustrating another exemplary embodiment of a surface light source device 50 having a supporting member 10 according to the present invention. The supporting member 10 of the present embodiment is same as in embodiment in FIG. 11 except for a supporting portion that is separately formed with a fixing portion 20. Thus, the same reference numerals will be used to refer to the same or like parts as those described in embodiment in FIG. 11 and any further explanation concerning the above elements will be omitted.

Referring to FIG. 12, a supporting member 10 includes a fixing portion 23 and a supporting portion 34. In exemplary embodiments, the supporting portion 34 may be separately formed with the fixing portion 23. In alternative embodiments, the supporting portion 34 may be combined with the fixing portion 23.

The fixing portion 23 may include a first combination portion 23a, and the supporting portion 34 may include a second combination portion 34a. The first combination portion 23a may be considered a protrusion of the fixing portion 23. Referring to FIG. 12, the first combination portion 23a protrudes upward from the fixing portion 23. The second combination portion 34a may be considered a recession of the supporting portion 34. Referring to FIG. 12, the second combination portion 34a is recessed into the bottom of the supporting portion 34. When the first combination portion 23a is inserted into the second combination portion 34a, the supporting portion 34 is combined with, or joined with, the fixing portion 23.

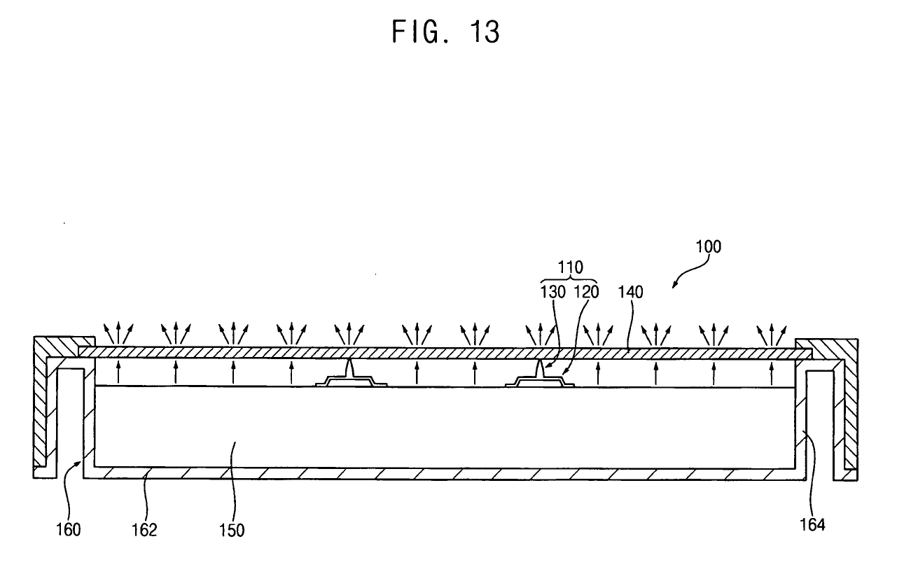

FIG. 13 is a cross-sectional view illustrating an exemplary embodiment of a backlight assembly according to the present invention.

Referring to FIG. 13, a backlight assembly 100 includes a supporting member 110, a light diffusing plate 140, a surface light source device 150 and a receiving container 160.

A receiving container 160 includes a bottom plate 162 and sidewalls 164. The bottom plate 162 has, for example, a rectangular plate shape, but may include any of a number of shapes suitable for the purpose described herein. The sidewalls 164 are disposed at edges of the bottom plate 162.

The surface light source device 150 may have a rectangular shape corresponding to the bottom plate 162 of the receiving container 160. The surface light source device 150 may include a plurality of light-emitting regions (not shown) and a plurality of non-emitting regions (not shown). The light-emitting regions and the non-emitting regions may alternate with each other. The surface light source device 150 is disposed on the bottom plate 162 of the receiving container 160.

The surface light source device 150 may induce a dark region due to the non-emitting regions. Therefore, luminance uniformity may be reduced.

In exemplary embodiments, to enhance luminance uniformity, the backlight assembly 100 may include the light diffusing plate 140. The light diffusing plate 140 is disposed over the surface light source device 150. The light diffusing plate 140 diffuses light generated by the surface light source device 150 to enhance the luminance uniformity.

The supporting member 110 may be disposed between the surface light 5 source device 150 and the light diffusing plate 140. The supporting member 110 supports the light diffusing plate 140 to prevent sagging of the light diffusing plate 140.

The supporting member 110 may include a fixing portion 120 and a supporting portion 130. The supporting member 110 may includes, for example, an optically transparent material such as polyethyleneterephthalate (PET), polymethylmethacrylate (PMMA), polycarbonate (PC), or the like, as well as any combination including at least one of the foregoing.

In exemplary embodiments, the fixing portion 120 may be disposed on a face of the surface light source device 150. For example, the fixing portion 120 may be disposed on a light-exiting face of the surface light source device 150. The fixing portion 120 essentially “fixes” the supporting portion 130 to the surface light source device 150. In other exemplary embodiments, an adhesive member (not shown) may be disposed between the light-exiting face of the surface light source device 150 and the fixing portion 120 to fix the supporting member 110 to the surface light source device 150. In alternative embodiments, a two-sided adhesive tape may be employed as the adhesive member.

The supporting portion 130 may be formed or disposed on the fixing portion 120. The supporting portion 130 makes contact with the optical member 140 to support the optical member 140.

The fixing portion 120 of the supporting member 110 has, for example, a plate shape, but may include any of a number of shapes suitable for the purpose described herein. The supporting portion 130 of the supporting member 110 has, for example, a cone shape. In other exemplary embodiments, the supporting member 130 may have a prism shape, cylindrical shape, but may include any of a number of shapes suitable for the purpose described herein. In alternative embodiments, the fixing portion 120 may include the contact portion 27, the center portion 29 and the connecting portion 28 as shown in the exemplary embodiment in FIG. 11.

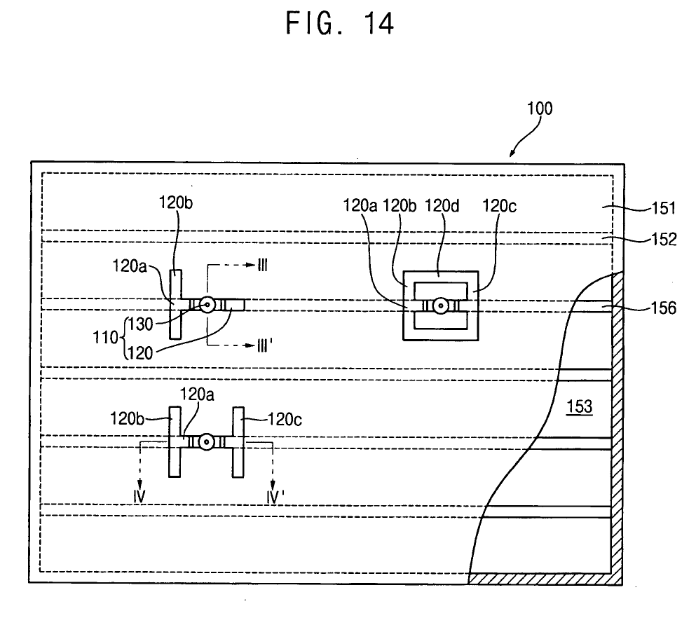

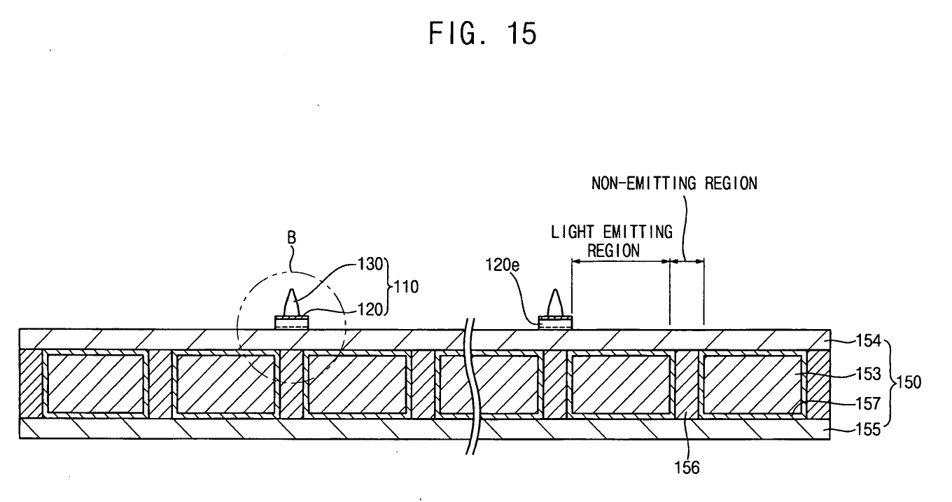

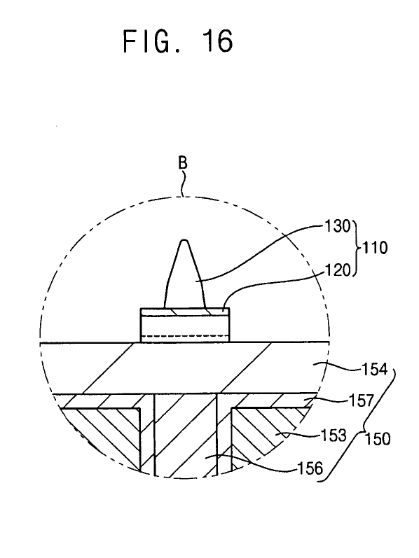

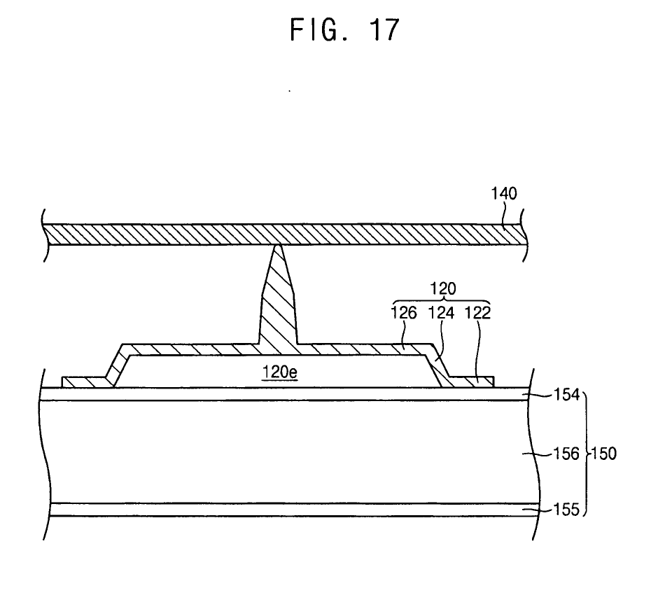

FIG. 14 is a plan view illustrating another exemplary embodiment of a backlight assembly according to the present invention. FIG. 15 is a cross-sectional taken along line III-III′ in FIG. 14. FIG. 16 is an enlarged view illustrating portion ‘B’ in FIG. 15. FIG. 17 is a cross-sectional view taken along line IV-IV′ in FIG. 14. The backlight assembly 100 of the present embodiment is the same as in embodiment in FIG. 13 except for a supporting member 110. Thus, the same reference numerals will be used to refer to the same or like parts as those described in embodiment in FIG. 13 and any further explanation concerning the above elements will be omitted.

Referring to FIGS. 14 through 17, a backlight assembly 100 according to the present embodiment includes a surface light source device 150. The surface light source device 150 includes a plurality of light-emitting regions 151 and a plurality of non-emitting regions 152. The light-emitting regions 151 and the non-emitting regions 151 may alternate with each other. The surface light source device 150 includes a first substrate 154 and a second substrate 155 facing the first substrate 154. When the first and second substrates 154 and 155 are combined with each other, a plurality of discharge spaces may be formed between the first and second substrates 154 and 155.

In exemplary embodiments, discharge gas 153 may be injected into the discharge spaces. A fluorescent layer 157 may be formed on a surface that makes contact with the discharge spaces.

The first and second electrodes may be disposed on at least one of the first and second substrates 154 and 155. The first and second electrodes may be disposed at first and second ends of the first and second substrates 154 and 155, the ends being opposite to each other. The first and second electrodes may be disposed such that a longitudinal direction of the first and second electrodes is substantially perpendicular to a longitudinal direction of the light-emitting regions 151. An electric power may be applied to the discharge gas 153 to generate invisible light. The invisible light then may be converted into visible light by the fluorescent layer 157.

A dark region may be induced due to the partition member 156 that defines the discharge spaces. In exemplary embodiments, to reduce the dark region, the surface light source device 150 may further include an optical member 40. The optical member 140 may be disposed over the first substrate 154. The optical member 140 may be spaced apart from the first substrate 154 to enhance luminance uniformity.

When the optical member 140 is spaced apart from the first substrate 154, the optical member 140 may sag due to the weight thereof. When the optical member 140 sags, luminance uniformity may be reduced.

In exemplary embodiments, to prevent sagging of the optical member 140, a supporting member 110 may be disposed between the first substrate 154 and the optical member 140. The supporting member 110 may be disposed, for example, on the non-emitting region 152. Advantageously, when the supporting member 110 is disposed on the non-emitting region 152, a luminance and a luminance uniformity may be enhanced. In exemplary embodiments, the supporting member 110 may include a fixing portion 120 and a supporting portion 130. The fixing portion 120 may be disposed on the non-emitting region 152 to advantageously enhance light-using efficiency.

The supporting member 110 may include an impact absorbing portion 120e. The impact absorbing portion 120e absorbs compression applied to the supporting portion 130. The fixing portion 120 may include a contact portion 122, a connecting portion 124 and a center portion 126 to form the impact absorbing portion 120e. The contact portion 122 makes contact with the surface light source device 150. The supporting member 110 is disposed on the surface light source device 150 through the contact portion 122. In exemplary embodiments, the contact portion 122 may be fixed to the surface light source device 150 through an adhesive member (not shown). The center portion 126 may be spaced apart from the surface light source device 150 forming a gap between the center portion 126 and the surface light source device 150. The gap between the center portion 126 and the surface light source device 150 may be substantially uniform. The connecting portion 124 connects the center portion 126 and the contact portion 122.

The supporting portion 130 may be disposed on the center portion 126. The supporting portion 130 supports an optical member 140, including but not limited to, a light diffusing plate.

When compression is applied to the optical member 140, the compression is transferred to the supporting portion 130. The compression applied to the supporting portion 130 is buffered by the center portion 126 of the impact absorbing piece 120e to reduce, or effectively prevent damages of the optical member 140 and the supporting member 110.

In exemplary embodiments, the connecting portion 124 may form an angle of about 30 degrees to about 60 degrees with respect to surface light source device 150. When the angle is smaller than 30 degrees, a gap between the center portion 126 and the surface light source device 150 may become too small to absorb the compression. When the angle is larger than about 60 degrees, a volume of the supporting member 110 may increase and the compression may not be absorbed properly.

In exemplary embodiments, the fixing portion 120 may include a first fixing piece 120a and a second fixing piece 120b. The first fixing piece 120a may be disposed on the non-emitting region 152. The second piece 120b may extend from an end portion of the first fixing piece 120a toward one of the light-emitting region 151 such that a longitudinal direction of the second fixing piece 120b is substantially perpendicular to a longitudinal direction of the first fixing piece 120a. In alternative embodiments, more than one of the second fixing piece 120b may extend in substantially opposite directions from a first end portion of the first fixing piece 120a toward light-emitting regions 151 essentially forming a T-shape.

In another embodiment, the fixing portion 120 may include a first fixing piece 120a, a second fixing piece 120b and a third fixing piece 120c. The first fixing piece 120a may be disposed on the non-emitting region 152. The second fixing piece 120b may extend from a first end portion of the first fixing piece 120a towards one of the light-emitting regions 151 such that a longitudinal direction of the second fixing piece 120b is substantially perpendicular to a longitudinal direction of the first fixing piece 120a. More than one of the second fixing piece 120b may extend from a first end portion of the first fixing piece 120a as is shown in FIG. 14.

The third fixing piece 120c may extend from a second end portion of the first fixing piece 120a towards one of the light-emitting regions 151, the second end portion being opposite to the first end portion, such that a longitudinal direction of the third fixing piece 120c is substantially perpendicular to a longitudinal direction of the first fixing piece 120a. More than one of the third fixing piece 120c may extend from a second end portion of the first fixing piece 120a as is shown in FIG. 14. The fixing portion 120 essentially forms an H-shape.

In another exemplary embodiment, the fixing portion 120 includes a first fixing piece 120a, a second fixing piece 120b, a third fixing piece 120c and a connecting piece 120d. The first fixing piece 120a may be disposed on the non-emitting region 152. The second fixing piece 120b may extend from a first end portion of the first fixing piece 120a toward one of the light-emitting region 151 such that a longitudinal direction of the second fixing piece 120b is substantially perpendicular to a longitudinal direction of the first fixing piece 120a. More than one of the second fixing piece 120b may extend from a first end portion of the first fixing piece 120a as is shown in FIG. 14.

The third fixing piece 120c may extend from a second end portion of the first fixing piece 120a toward one of the light-emitting region 151, the second end portion being opposite to the first end portion, such that a longitudinal direction of the third fixing piece 120c is substantially perpendicular to a longitudinal direction of the first fixing piece 120a. More than one of the third fixing piece 120c may extend from a second end portion of the first fixing piece 120a as is shown in FIG. 14.

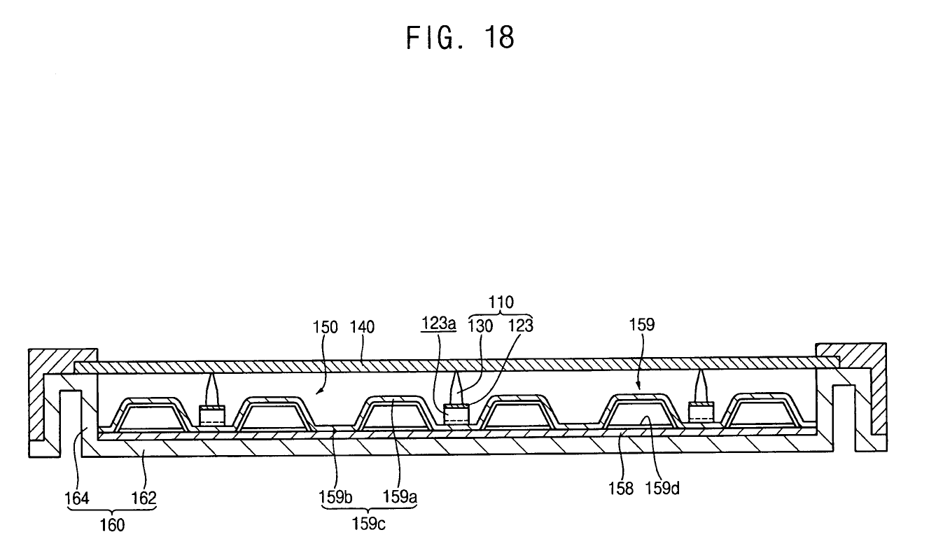

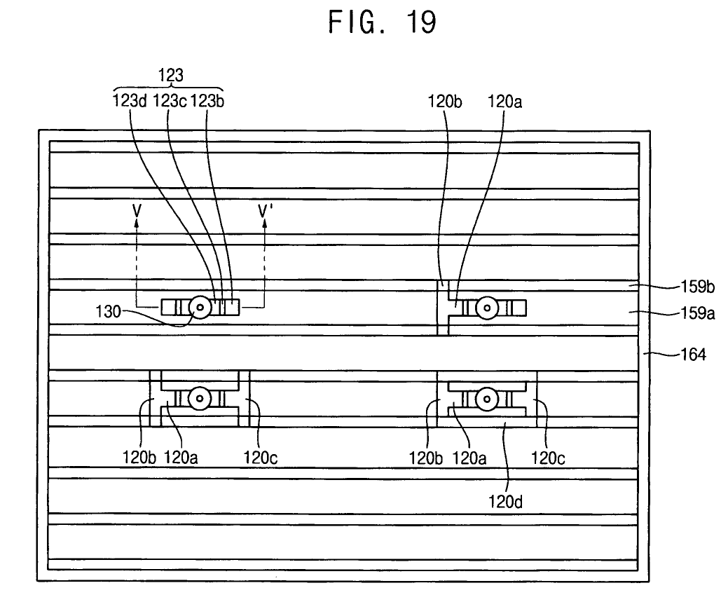

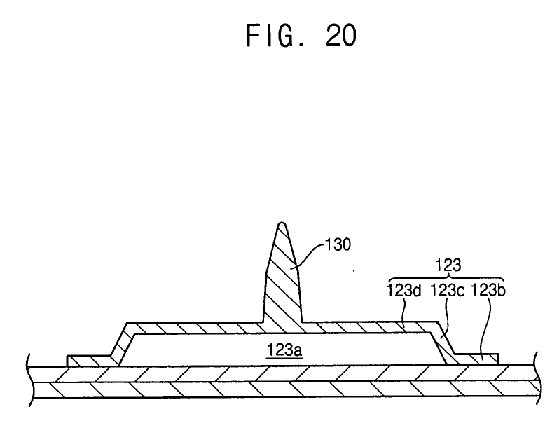

The connecting piece 120d may be disposed such that the connecting piece 120d is substantially parallel with the first fixing piece 120a. The connecting piece 120d connects end portions of the second and third fixing pieces 120b and 120c. The second and third fixing pieces 120b and 120c may intrude on the light-emitting region 151, so that the connecting piece 120d is disposed on the light-emitting region 151. Advantageously, the connecting piece 120d may increase the strength of the fixing portion 120. FIG. 18 is a cross-sectional view illustrating another exemplary embodiment of a backlight assembly according to the present invention. FIG. 19 is a plan view illustrating another backlight assembly. FIG. 20 is a cross-sectional view taken along line V-V′ in FIG. 19. The backlight assembly of the present embodiment is same as in embodiment in FIGS. 14 through 17 except for a surface light source device 150 and a fixing portion. Thus, the same reference numerals will be used to refer to the same or like parts as those described in embodiment in FIGS. 14 through 17 and any further explanation concerning the above elements will be omitted.

Referring to FIGS. 18 through 20, a surface light source device 150 includes a first substrate 158 and a second substrate 159 facing the first substrate 158. An optical member 140 is disposed over the second substrate 159. The second substrate 159 has a plurality of ridges 159a and a plurality of grooves 159b that make contact with the first substrate 158. The ridges 159a and the grooves 159b may alternate with each other. The grooves 159b divide an inner space between the first and second substrates 158 and 159 into a plurality of discharge spaces. A light emitting portion 159c is defined by two grooves 159b adjacent to each other, and one of the ridges 159a disposed between the two grooves 159b.

In exemplary embodiments, the ridges 159a may correspond to the light-emitting regions, and the grooves 159b may correspond to the non-emitting region. A cross section of the ridges 159a may have various shapes such as a semicircle, a trapezoid, a triangle, a rectangle, but may include any of a number of shapes suitable for the purpose described herein. The ridges 159a and the grooves 159b may extend, for example, along a longitudinal direction of the surface light source device 150. The light emitting portions 159c may be substantially parallel with each other. In other exemplary embodiments, the light emitting portions 159c may be spaced apart from each other by an interval of about 2 mm to about 4 mm.

A fluorescent layer 159d may be formed on an inner surface of the light emitting portion 159c. Discharge gas is injected into discharge spaces defined by the light emitting portion 159c of the second substrate 159 and the first substrate 158. The discharge gas may include, but is not limited to, mercury (Hg), argon (Ar), neon (Ne), xenon (Xe), krypton (Kr), or the like.

In another exemplary embodiment, the surface light source device 150 may further include a first electrode (not shown) and a second electrode (not shown). The first and second electrodes may be disposed on at least one of the first and second substrates 158 and 159. In other embodiments, the first and second electrodes may be disposed at first and second ends that are opposite to each other, respectively. In other embodiments, the first and second electrodes may be disposed such that a longitudinal direction of the first and second electrodes is substantially perpendicular to a longitudinal direction of the light-emitting portion 159c. An electric power may be applied to the discharge gas to generate invisible light. In alternative embodiments, the first and second electrodes may be disposed in the surface light source device 150. The invisible light may then be converted into visible light by the fluorescent layer 159d.

In exemplary embodiments, the supporting member 110 may include an impact absorbing portion 123a. The impact absorbing portion 123a absorbs compression applied to the supporting portion 130. The fixing portion 123 may include a contact portion 123b, a connecting portion 123c and a center portion 123d to form the impact absorbing portion 123a. The contact portion 123b makes contact with the surface light source device 150. The supporting member 110 may be disposed on the surface light source device 150 through the contact portion 123b. In other exemplary embodiments, the contact portion 123b may be fixed to the surface light source device 150 through an adhesive member (not shown). The center portion 123d may be spaced apart from the surface light source device 150 forming a gap between the center portion 123d and the surface light source device 150. A gap between the center portion 123d and the surface light source device 150 may be substantially uniform. The connecting portion 123c connects the center portion 123d and the contact portion 123b.

The supporting portion 130 may be disposed on the center portion 123d. The supporting portion 130 supports an optical member 140, including, but not limited to, a light diffusing plate 140.

When compression is applied to the light diffusing plate 140, the compression is transferred to the supporting portion 130. The compression applied to the supporting portion 130 is buffered by the center portion 123d to reduce, or effectively prevent damage of the light diffusing plate 140 and the supporting member 110.

In exemplary embodiments, the connecting portion 123c may form an angle of about 30 degrees to about 60 degrees with respect to surface light source device 150. When the angle is smaller than about 30 degrees, a gap between the center portion 123d and the surface light source device 150 may become too small to absorb the compression. When the angle is larger than about 60 degrees, a volume of the supporting member 110 may increase and the compression may not be absorbed properly.

Referring to FIG. 19, the fixing portion 123 may include a first fixing piece 120a and a second fixing piece 120b. The first fixing piece 120a is disposed on the grooves 159b, and the second piece 120b is extended from an end portion of the first fixing piece 120a such that a longitudinal direction of the second fixing piece 120b is substantially perpendicular to a longitudinal direction of the first fixing piece 120a. The second fixing piece 120b may intrude the ridges 159a adjacent to the groove 159b on which the first fixing piece 120a is disposed, essentially forming a T-shape.

In another exemplary embodiment, the fixing portion 123 includes a first fixing piece 120a, a second fixing piece 120b and a third fixing piece 120c. The first fixing piece 120a may be disposed on the grooves 159b. The second fixing piece 120b may extend from a first end portion of the first fixing piece 120a such that a longitudinal direction of the second fixing piece 120b is substantially perpendicular to a longitudinal direction of the first fixing piece 120a. The third fixing piece 120c may extend from a second end portion of the first fixing piece 120a, the second end portion being opposite to the first end portion, such that a longitudinal direction of the third fixing piece 120c is substantially perpendicular to a longitudinal direction of the first fixing piece 120a. The second and third fixing pieces 120b and 120c may intrude the ridges 159a adjacent to the groove 159b on which the first fixing piece 120a is disposed. The fixing portion 123 essentially forms an H-shape.

In another exemplary embodiments, the fixing portion 123 may include a first fixing piece 120a, a second fixing piece 120b, a third fixing piece 120c and a connecting piece 120d. The first fixing piece 120a is disposed on the grooves 159b. The second fixing piece 120b may extend from a first end portion of the first fixing piece 120a such that a longitudinal direction of the second fixing piece 120b is substantially perpendicular to a longitudinal direction of the first fixing piece 120a. The third fixing piece 120c may extend from a second end portion of the first fixing piece 120a, the second end portion being opposite to the first end portion, such that a longitudinal direction of the third fixing piece 120c is substantially perpendicular to a longitudinal direction of the first fixing piece 120a. The connecting piece 120d may be disposed such that the connecting piece 120d is substantially parallel with the first fixing piece 120a. The connecting piece 120d connects end portions of the second and third fixing pieces 120b and 120c. The second and third fixing pieces 120b and 120c may intrude the ridges 159a adjacent to the groove 159b on which the first fixing piece 120a is disposed, so that the connecting piece 120d is disposed on the groove 159b subsequent to the adjacent ridges 159a. Advantageously, the connecting piece 120d may increase the strength of the fixing portion 123.

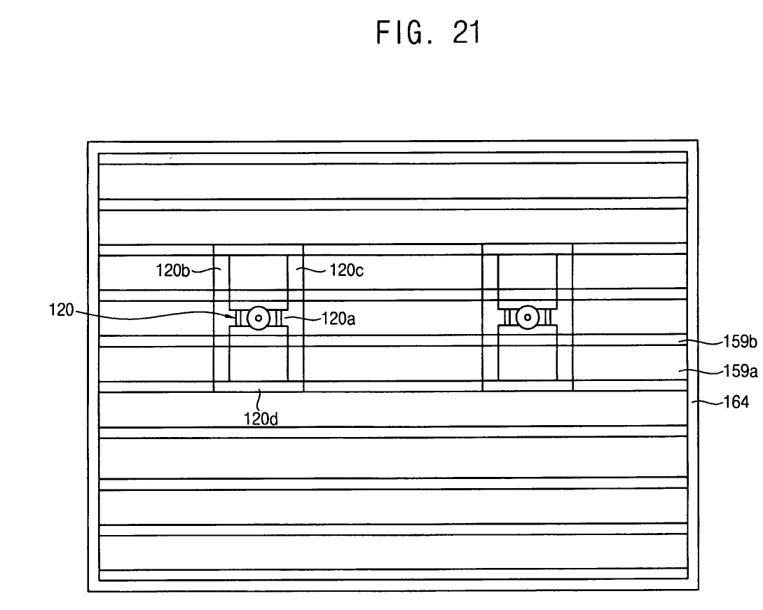

FIG. 21 is a plan view illustrating another exemplary embodiment of a backlight assembly according to the present invention. The backlight assembly of the present embodiment is same as in embodiment in FIGS. 18 through 20 except for a supporting member 110. Thus, the same reference numerals will be used to refer to the same or like parts as those described in embodiment in FIGS. 18 through 20 and any further explanation concerning the above elements will be omitted.

Referring to FIG. 21, a fixing portion 120 includes a first fixing piece 120a, a second fixing piece 120b, a third fixing piece 120c and a connecting piece 120d. The first fixing piece 120a is disposed on the ridge 159a. The second fixing piece 120b extends from a first end portion of the first fixing piece 120a such that a longitudinal direction of the second fixing piece 120b is substantially perpendicular to a longitudinal direction of the first fixing piece 120a. The third fixing piece 120c extends from a second end portion of the first fixing piece 120a, the second end portion being opposite to the first end portion, such that a longitudinal direction of the third fixing piece 120c is substantially perpendicular to a longitudinal direction of the first fixing piece 120a. The connecting piece 120d is disposed such that the connecting piece 120d is substantially parallel with the first fixing piece 120a. The connecting piece 120d connects end portions of the second and third fixing pieces 120b and 120c. The second and third fixing pieces 120b and 120c intrude the grooves 159b immediately adjacent to the ridge 159a on which the first fixing piece 120a is disposed. The second and third fixing pieces 120b and 120c may also intrude subsequent ridges 159a and grooves 159b. For example, in FIG. 21, the second and third fixing pieces 120b and 120c extending from the first fixing piece 120a in a direction substantially perpendicular to the first fixing piece 120a, intrude on a one ridge 159a and two grooves 159b on either side of the ridge 159a upon which the first fixing piece 120a is disposed. The connecting piece 120d is disposed on the furthermost groove 159b which the second and third fixing pieces 120b and 120c intrude. Advantageously, the connecting piece 120d may increase the strength of the fixing portion 120.

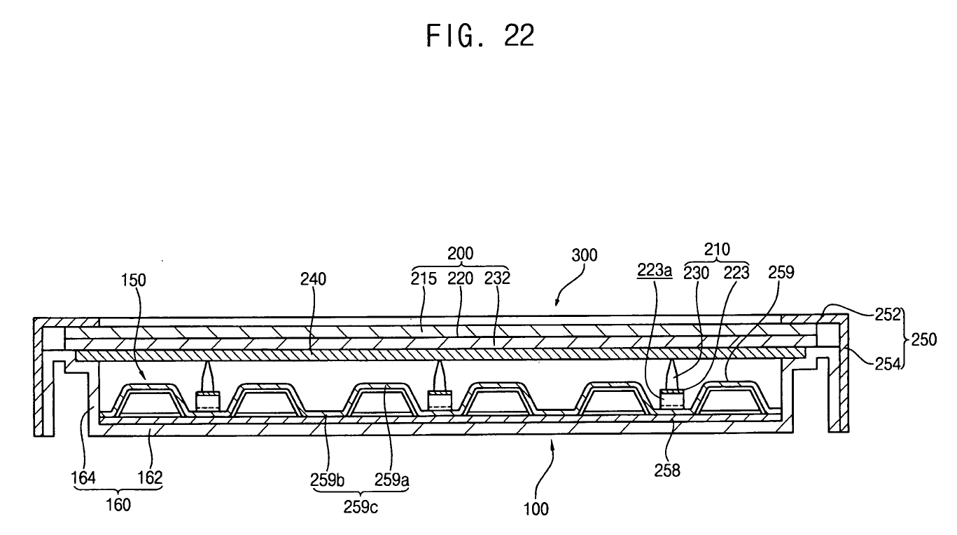

FIG. 22 is a cross-sectional view illustrating an exemplary embodiment of a display apparatus according to the present invention.

Referring to FIG. 22, a display apparatus 300 includes a backlight assembly 100 and a display panel 200. The display apparatus 300 may further include a chassis 250.

The backlight assembly 100 includes a supporting member 210, a light diffusing plate 240, a surface light source device 150 and a receiving container 160.

The surface light source device 150 includes a first substrate 258 and a second substrate 259 facing the first substrate 258. An optical member 240 is disposed over the second substrate 259. The second substrate 259 has a plurality of ridges 259a and a plurality of grooves 259b that make contact with the first substrate 258. The ridges 259a and the grooves 259b may alternate with each other. The grooves 259b divide an inner space between the first and second substrates 258 and 259 into a plurality of discharge spaces. A light emitting portion 259c is defined by two grooves 259b adjacent to each other, and one of the ridges 259a disposed between the two grooves 259b.

In exemplary embodiments, the ridges 259a may correspond to the light-emitting regions, and the grooves 259b may correspond to the non-emitting region. A cross section of the ridges 259a may have various shapes such as a semicircle, a trapezoid, a triangle, a rectangle, but may include any of a number of shapes suitable for the purpose described herein. The ridges 259a and the grooves 259b may extend, for example, along a longitudinal direction of the surface light source device 150. The light emitting portions 259c may be substantially parallel with each other. In other exemplary embodiments, the light emitting portions 259c may be spaced apart from each other by an interval of about 2 mm to about 4 mm.

In another exemplary embodiment, the surface light source device 150 may further include a first electrode (not shown) and a second electrode (not shown). The first and second electrodes may be disposed on at least one of the first and second substrates 258 and 259. In other embodiments, the first and second electrodes may be disposed at first and second ends that are opposite to each other, respectively. In other embodiments, the first and second electrodes may be disposed such that a longitudinal direction of the first and second electrodes is substantially perpendicular to a longitudinal direction of the light-emitting portion 259c. An electric power may be applied to discharge gas to generate invisible light. In alternative embodiments, the first and second electrodes may be disposed in the surface light source device 150. The invisible light may then be converted into visible light by a fluorescent layer. The receiving container 160 may include a bottom plate 162 and sidewalls 164. The bottom plate 162 may have, for example, a rectangular plate shape, but other shapes may be employed as is suitable for the purpose described herein. The sidewalls 164 are disposed at edges of the bottom plate 162.

The surface light source device 150 may have a rectangular shape corresponding to the bottom plate 162 of the receiving container 160. The surface light source device 150 may include a plurality of light-emitting regions and a plurality of non-emitting regions. The light-emitting regions and the non-emitting regions may alternate with each other. The surface light source device 150 is disposed on the bottom pate 162 of the receiving container 160.

The surface light source device 150 may induce a dark region due to the non-emitting regions. Therefore, luminance uniformity may be reduced.

In exemplary embodiments, to enhance luminance uniformity, the backlight assembly 100 may include the light diffusing plate 240. The light diffusing plate 240 is disposed over the surface light source device 150. The light diffusing plate 240 diffuses light generated by the surface light source device 150 to enhance the luminance uniformity.

The supporting member 210 may be disposed between the surface light source device 150 and the light diffusing plate 240. The supporting member 210 supports the light diffusing plate 240 to prevent sagging of the light diffusing plate 240.

The supporting member 210 may include a fixing portion 223 and a supporting portion 230. The supporting member 210 may include, but is not limited to, an optically transparent material such as polyethyleneterephthalate (PET), polymethylmethacrylate (PMMA), polycarbonate (PC), or the like, as well as any combination including one of the foregoing.

The fixing portion 223 may be disposed on a face of the surface light source device 150. For example, the fixing portion 223 may be disposed on a light-exiting face of the surface light source device 150. The fixing portion 223 essentially fixes the supporting portion 230 to the surface light source device 150. In other exemplary embodiments, an adhesive member (not shown) may be disposed between the light-exiting face of the surface light source device 150 and the fixing portion 223 to fix the supporting member 210 to the surface light source device 150. In alternative embodiments, a both-sided adhesive tape may be employed as the adhesive member. The supporting portion 230 may be formed or disposed on the fixing portion 223. The supporting portion 130 makes contact with the optical member 140 to support the optical member 140. In exemplary embodiments, the supporting member 210 may include an impact absorbing portion 223a. The impact absorbing portion 223a absorbs compression applied to the supporting portion 230.

The fixing portion 120 of the supporting member 110 has, for example, a plate shape, but may include any of a number of shapes suitable for the purpose described herein. The supporting portion 230 of the supporting member 210 has, for example, a cone shape. In other exemplary embodiments, the supporting member 210 may have a prism shape, cylindrical shape, but may include any of a number of shapes suitable for the purpose described herein. In alternative embodiments, the fixing portion 223 may include the contact portion, the center portion and the connecting portion.

In exemplary embodiments, the display panel 200 may include a thin film transistor (TFT) substrate 232, a color filter substrate 215 and a liquid crystal layer 220. The TFT substrate 232 may include a plurality of TFTs (not shown) arranged in a matrix shape. The color filter substrate 215 may include a color filter layer and a common electrode. The liquid crystal layer 220 is disposed between the TFT substrate 232 and the color filter substrate 215 as shown in the exemplary embodiment of FIG. 22.

The chassis 250 fastens the display panel 200 to the receiving container 160. The chassis 250 may include a first chassis portion 252 and a second chassis portion 254. The first chassis portion 252 may surround and compress edge portions of the display panel 200, and the second chassis portion 254 may extend from end portions of the first chassis portion 252 along the sidewalls 164 of the receiving container 160. The second chassis portion 254 may be combined with the sidewalls 164, for example, through a hook combination.Advantageously, sagging of the optical member may be prevented, so that display quality may be enhanced.

Having described the exemplary embodiments of the present invention and its advantages, it is noted that various changes, substitutions and alterations can be made herein without departing from the spirit and scope of the invention as defined by appended claims.

What is claimed is:

1. A supporting member comprising:
a fixing portion on a surface face of a light source device; and
a supporting portion disposed on the fixing portion to support an optical member.

2. The supporting member of claim 1, wherein the light source device corresponds to a surface light source device.

3. The supporting member of claim 1, wherein the supporting portion has a polygonal pyramid shape.

4. The supporting member of claim 1, wherein the supporting portion has a cone shape.

5. The supporting member of claim 1, wherein a top of the supporting portion is rounded.

6. The supporting member of claim 1, wherein the supporting portion includes a hollow formed therein.

7. The supporting member of claim 2, wherein the supporting portion comprises a luminance-uniformizing section formed at a side of the supporting portion.

8. The supporting member of claim 2, wherein the fixing portion is disposed on a non-emitting region, the non-emitting region being disposed between light-emitting regions of the surface light source device.

9. The supporting member of claim 8, wherein the fixing portion comprises a first fixing piece disposed on the non-emitting region, and a second fixing piece extended from the first fixing piece toward the light-emitting region such that a longitudinal direction of the second fixing piece is substantially perpendicular to a longitudinal direction of the first fixing piece.

10. The supporting member of claim 9, wherein the second fixing piece is extended from a first end portion of the first fixing piece.

11. The supporting member of claim 9, wherein the fixing portion further comprises a third fixing piece extended from a second end portion of the first fixing piece.

12. The supporting member of claim 2, wherein the surface light source device comprises a plurality of ridges, and the fixing portion comprises a first fixing piece that is disposed along the grooves between the ridges adjacent to each other, and a second fixing piece that is extended from the first fixing piece toward the ridges, the second fixing portion being formed substantially along a surface of the ridges.

13. The supporting member of claim 2, wherein the fixing portion comprises a contact portion contacting with the surface light source device, a center portion spaced apart from the surface light source device, and a connecting portion connecting the center portion with the contact portion.

14. The supporting member of claim 13, wherein the connecting portion forms an angle of about 30 degrees to about 60 degrees with respect to the surface light source device.

15. The supporting member of claim 2, wherein the fixing portion is attached to the surface light source device by an adhesive member.

16. The supporting member of claim 2, wherein the supporting portion is detachably attached to the fixing portion by a first combination portion formed at the fixing portion and a second combination portion formed at the supporting portion.

17. The supporting member of claim 16, wherein the first combination portion corresponds to a protrusion and the second combination portion corresponds to a recession receiving the protrusion.

18. A backlight assembly comprising:
a receiving container having a bottom plate;
a surface light source device disposed on the bottom plate of the receiving container, the surface light source device generating light;
an optical member that enhances optical property of the light generated by the surface light source device; and
a supporting member disposed between the surface light source device and the optical member to support the optical member, the supporting member including a fixing portion disposed on the surface light source device, and a supporting portion disposed on the fixing portion to support the optical member.

19. The backlight assembly of claim 18, wherein the surface light source device comprises a first substrate and a second substrate combined with the first substrate to define a plurality of light-emitting regions and a plurality of non-emitting regions, each of the non-emitting regions is disposed between the light-emitting regions adjacent to each other.

20. The backlight assembly of claim 19, wherein the fixing portion is disposed at the non-emitting region.

21. The backlight assembly of claim 20, further comprising an impact absorbing portion disposed between the surface light source device and the fixing portion.

22. The backlight assembly of claim 20, wherein the fixing portion comprises a contact portion contacting with the surface light source device, a center portion spaced apart from the surface light source device, and a connecting portion connecting the center portion with the contact portion.

23. The backlight assembly of claim 22, wherein the connecting portion forms an angle of about 30 degrees to about 60 degrees with respect to the surface light source device.

24. The backlight assembly of claim 19, wherein the fixing portion comprises a first fixing piece disposed at one of the non-emitting regions, and a second fixing piece extended from a first end portion of the first fixing piece toward the light-emitting region such that a longitudinal direction of the second fixing piece is substantially perpendicular to a longitudinal direction of the first fixing portion.

25. The backlight assembly of claim 24, wherein the fixing portion further comprises a third fixing piece extended from a second end portion of the first fixing piece toward the light-emitting region such that a longitudinal direction of the third fixing piece is substantially perpendicular to a longitudinal direction of the first fixing portion.

26. The backlight assembly of claim 24, wherein the fixing portion further comprises a connecting piece connecting end portions of the second and third fixing pieces.

27. The backlight assembly of claim 18, wherein the surface light source device comprises a first substrate and a second substrate facing the first substrate, and the second substrate comprises ridges and grooves alternating with each other to define a plurality of discharge spaces.

28. The backlight assembly of claim 27, wherein the fixing portion is disposed at the grooves.

29. The backlight assembly of claim 27, wherein the fixing portion comprises a first fixing pieces disposed at the grooves and a second fixing portion extended from the first fixing portion toward the ridges, and the second fixing portion is substantially formed along a surface of the second substrate.

30. The backlight assembly of claim 29, wherein the second fixing piece is extended from a first end of the first fixing piece.

31. The backlight assembly of claim 30, wherein the fixing portion further comprises a third fixing portion extended from a second end of the first fixing portion toward the ridges, and the third fixing portion is substantially formed along a surface of the second substrate.

32. The backlight assembly of claim 31, wherein the second and third fixing pieces are extended from a first fixing portion, so that the first, second and third fixing pieces form an H-shape.

33. The backlight assembly of claim 31, wherein the second and third fixing pieces are extended to intrude ridges adjacent to the groove where the fixing portion is disposed to reach a next groove adjacent to the ridges.

34. The backlight assembly of claim 32, wherein the fixing portion further comprises a connecting piece that connects end portions of the second and third fixing pieces, the connecting piece being disposed at a groove subsequent to the groove where the fixing portion is disposed.

35. The backlight assembly of claim 29, wherein each of the grooves has a width of about 2 mm to about 4 mm.

36. The backlight assembly of claim 18, wherein the fixing portion of the supporting member is attached to the surface light source device by a double-face adhesive tape disposed between the fixing portion and the surface light source device.

37. A backlight assembly comprising:
a surface light source device having a first substrate and a second substrate facing the first substrate to form a light-emitting region and a non-emitting region, the surface light source device generating light;
an optical member that enhances optical properties of the light generated by the surface light source device;
a supporting member disposed at the non-emitting region of the surface light source device to support the optical member; and
a receiving container that receives the surface light source device and the optical member.

38. The backlight assembly of claim 37, wherein the supporting member comprises a fixing portion disposed on the surface light source device to fasten the supporting member to the surface light source device and a supporting portion formed on the fixing portion to support the optical member, the fixing portion comprising a contact portion contacting with the surface light source device, a center portion spaced apart from the surface light source device, and a connecting portion connecting the center portion with the contact portion.

39. The backlight assembly of claim 38, wherein the connecting portion forms an angle of about 30 degrees to about 60 degrees with respect to the surface light source device.

40. A display apparatus comprising:
a backlight assembly that generates light, the backlight assembly including:
a surface light source device having a first substrate and a second substrate facing the first substrate to form a light-emitting region and a non-emitting region, the surface light source device generating light;
an optical member that enhances optical properties of the light generated by the surface light source device;
a supporting member disposed at the non-emitting region of the surface light source device to support the optical member; and
a receiving container that receives the surface light source device and the optical member; and
a display panel that displays images by using the light generated by the backlight assembly.
